(19) United States
(12) Patent Application Publication
(10) Pub. No.: US 2014/0303059 A1
(43) Pub. Date: Oct. 9, 2014

(54) Bleach Catalyst Particle

(71) Applicants: Kai Heppert, Ludwigshafen (DE); Steffen Lingler, Ludwigshafen (DE)

(72) Inventors: Kai Heppert, Ludwigshafen (DE); Steffen Lingler, Ludwigshafen (DE)

(73) Assignee: RECKITT BENCKISER N.V., Hoofddorp (DE)

(21) Appl. No.: 13/994,750

(22) PCT Filed: Dec. 9, 2011
(86) PCT No.: PCT/GB2011/052443

§ 371 Date: Oct. 8, 2013

(30) Foreign Application Priority Data
Dec. 21, 2010 (GB) 1021541.6

(51) Int. Cl. C11D 3/39

(52) U.S. Cl. CPC C11D 3/3935
USPC 510/224

(57) ABSTRACT

The invention relates to a particle comprising a bleach catalyst, a sulphonated polymer and a coating material. The particles are suitable for use in detergent compositions.

The present invention relates to particles comprising oxidation catalysts. The particles containing the oxidation catalysts are useful in detergent compositions.

Peroxide-containing bleaching agents have been used in washing and cleaning processes for some time. Such agents are particularly useful in dishwasher applications to aid the removal of foodstuff residues and stains produced on crockery and other kitchenware in cooking processes. Their action is particularly important on coloured stains such as those produced by tomato based foodstuffs and tea.

Peroxide-containing bleaching agents have been found to perform well at a liquor temperature of 90° C. and above, but their performance noticeably decreases with lower temperatures. (Typically dishwashers run between 60 and 70° C.) Thus when crockery and other kitchenware is washed in a dishwasher at lower temperatures, there can be a problem of incomplete stain removal. This is unpleasant from an aesthetic point of view and also can present detrimental hygiene issues.

It is well known that various transition metal ions, added in the form of suitable salts, or co-ordination compounds containing such cations catalyse the decomposition of H₂O₂. In that way it is possible to increase the bleaching action of H₂O₂ (or of precursors that release H₂O₂, or of other peroxo-compounds) the at lower temperatures. Particularly significant in the dishwasher context are those combinations of transition metal ions and ligands that demonstrate an increased tendency towards oxidation in respect of substrates (stains and foodstuffs) and not only in a catalase-like disproportionation. The latter activation, which tends rather to be undesirable in the present case, could actually impair the bleaching effects of H₂O₂ at low temperatures.

It is well known that transition metal compounds are often sensitive to environmental conditions (moisture, heat, air, etc) and can be both difficult to handle and store. This is due to the chemical reactivity of these compounds.

These issues have been considered in the prior art. Particulate and granular forms of these catalysts are known to improve the ease of handling and storage of these materials. And to improve the ease to which they can be incorporated into detergent compositions.

WO 96/37593 teaches the protection of redox active substances by agglomeration of such substances with excipients. The redox active materials can be metal salts. The presented solution, however, has the downside of consuming more excipients (compared to the coating material consumed in the present invention) and has as a result still some redox active material on the surface of the granule which can interact with air or formulation ingredients. Furthermore upon abrasion such granules release redox substances containing dust which might react with the rest of the formulation.

Coating of particulate materials is already known. For example, GB-A-2428694, WO 03/093405 and WO 02/066592 teach the coating of bleach catalyst granules to improve stability thereof. It is also known to prepare bleach catalyst granules which are substantially free from easily oxidisable material and which includes a carrier material and a binder agent.

WO2009/040545 discloses coated bleach catalyst granules that are coated with citric acid.

None of the above solutions have completely solved the problem. For example, while the particles described in WO2009/040545 demonstrate excellent storage stability, there are serious production issues in their preparation. These are associated with powerful exotherms produced during the particle formation, leading to serious fire risk.

It is the object of the present invention to obviate/mitigate the problems outlined above and/or to further improve the stability of particulate bleach catalysts.

According to a first aspect of the present invention there is provided a particle comprising a bleach catalyst and a sulphonated polymer wherein the particle is at least partially coated by a coating material.

The particles of the present invention demonstrate excellent storage stability and can be prepared with less production problems than those in the prior art.

Without wishing to be bound by theory it is postulated that combining the bleach catalyst with a sulphonated polymer to form a particle and then coating, provides substantial additional stability over just coating alone. The sulphonated polymer may provide this additional stability through coordination of the sulphonate groups to the bleach catalysts. The coating is presumed to add stability by creating a barrier to detrimental species such as aerial oxygen.

According to a second aspect of the present invention, there is provided a detergent composition comprising the particles of the present invention.

The present invention utilises a bleach catalyst.

Preferably the bleach catalyst comprises a transition metal compound based upon one or more of manganese, copper, iron, silver, platinum, cobalt, nickel, titanium, zirconium, tungsten, molybdenum, ruthenium, cerium, lanthanum or vanadium.

The metal catalyst may be used with a wide variety of different ligand species known in the art.

Most preferably the bleach catalyst comprises a transition metal compound based upon manganese.

The manganese bleach catalyst may be selected from wide range of manganese compounds. Suitable inorganic compounds (often salts) of manganese (e.g. Mn (II)) include hydrated/anhydrous halide (e.g. chloride/bromide), sulphate, sulphide, carbonate, nitrate, oxide. Further examples of suitable compounds (often salts) of manganese (e.g. Mn (II)) include hydrated/anhydrous acetate, lactate, acetyl acetonate, cyclohexanebutyrate, phthalocyanine, bis (ethylcyclopentadienyl), bis (pentamethylcyclopentadienyl).

Most preferably the bleach catalyst comprises manganese (II) acetate tetrahydrate and/or manganese (II) sulphate monohydrate.

The present invention also utilises a sulphonated polymer.

By sulphonated polymer, this means the polymer has sulphur containing functional groups that have a highly oxidized sulphur atom, such as sulphones and sulfonic acids, their salts and derivatives thereof.

The polymer may be comprised entirely of sulphonated monomers, or the polymer may be comprised of different monomers, only some of which are sulphonated. By entirely, this means the core of the particle, under the coating layer.

Particularly preferred sulphonated polymers are AA/AMPS copolymers. This is a copolymer of acrylic acid (AA) and 2-acrylamido-2-methylpropanesulfonic acid (AMPS).

The polymers may be of varying molecular weight. The weight ratio of AA:AMPS in the polymers is preferably between 90:10 to 10 to 90. More preferably between 25:75 and 75:25, most preferably between 70:30 and 60:40.

Particularly preferred AA/AMPS copolymers can be sourced from the Dow chemical company under the trade name Acusol 588G™ or BASF under the tradename Sokolan cp50™.

The particles of the present invention may be prepared by any method known in the art. These may include granulation, extrusion and compaction. A particularly preferred method of preparation of the particles of the present invention is via granulation.

The preferred particle size is in the range of from 0.05 mm to 25 mm, more preferably from 0.1 mm to 10 mm, more preferably between 0.2 mm to 5 mm, more preferably 0.3 to 2.0 mm and most preferably from 0.5 mm to 1.5 mm.

The particles are preferably spherical.

Preferably the particle comprises between 10-90% by weight of bleach catalyst and between 10-90% by weight of sulphonated polymer. More preferably the particle comprises between 20-50% by weight of bleach catalyst and between 50-80% by weight of sulphonated polymer. The weight percentages described are calculated prior to the application of the coating material and relate to the core uncoated particle.

The particles may comprise further components as required. These components may include lubricants, binders, disintegrant flowing aids, rheology modifiers, fillers, emulgators.

The core of the particles, ie that may also consist solely of the bleach catalyst and the sulphonated polymer.

The present invention utilises a coating material to at least partially coat the particles comprising the bleach catalyst and sulphur containing polymers.

Preferably the coating material completely coats the particles.

The coatings may comprise polymers, such as, PVA (polyvinyl acetate), PVOH (polyvinyl alcohol), PMA (poly methyl acrylate), PAA (polyacrylic acid), and co-polymers and mixtures thereof.

It has surprisingly been found that sugar compounds make excellent coating materials for the particles of the present invention. Preferably then, the coating material may comprise a sugar compound. The sugar compound may be a mono-saccharide, disacharride, polysaccharide or sugar alcohol or mixtures of the above.

A particularly preferred sugar alcohol is mannitol. Other preferred sugars include glucose, fructose, galactose, sucrose, lactose and maltose

The coating material may comprise further additives. Or the coating material may be used in an essentially pure form.

The coating material preferably comprises between 10 and 60% by weight of the total weight of the coated particles. More preferably the coating material comprises between 20 and 50% by weight of the total weight of the particles and most preferably between 30 and 40% by weight of the total weight of the particles.

Alternatively the coating material may comprise between 10 and 150% percent by weight of the core (non coated) particle, preferably between 15 and 100% and most preferably between 20 and 60% by weight of the core.

A particularly preferred particle of the present invention comprises a 70:30 weight ratio of particle to coating material. The particle comprises 35-45% by weight Mn (II) acetate and 55-65% by weight Acusol 588G™. (An AA (acrylic acid): AMPS (Acrylamido-methyl-propane sulfonate) copolymer available from the Dow chemical company). The coating material comprises mannitol.

As a percentage of the total weight of the coated particle, a particularly preferred particle comprises between 20-30% Mn (II) acetate, between 40-50% Acusol 588G and between 20-40% mannitol.

A non limiting method of preparing the preferred particles according to the present invention is outlined below

The formulation and coating of the particles was carried out in a 2-step process. Firstly the particles were prepared by granulation of an aqueous solution comprised of a 2:1 weight ratio of Acusol 588G™ and manganese (II) acetate was conducted in a Glatt fluid bed machine with a starting weight of manganese (II) acetate of 20 kg.

In a first step the resulting granules were dried in the fluidized bed unit until reaching the product temperature of 60° C.

The process conditions were:

| | |
|---|---|
| Inlet air-Volume: | 900 m3/h |
| Inlet air-Temperature: | 140° C. |
| Product-Temperature: | 60-70° C. |
| Outlet air-Temperature: | 44-53° C. |

In a second step the manganese (II) acetate/Accusol 588G granules were coated with mannitol using a 40% aqueous solution of mannitol. The spray rate of coating solution was 20 kg/h.

The process conditions were as follows:

| | | |
|---|---|---|
| Inlet air-Volume: | 900 | m3/h |
| Inlet air-Temperature: | 160° | C. |
| Product-Temperature: | 60-80° | C. |
| Outlet air-Temperature: | 63-77° | C. |
| Spray air-Pressure: | 3.0 | bar |

| | |
|---|---|
| Spray air-Temperature: | RT (room temperature) |

At the end of step 2 the coated particles were allowed to reach ambient temperature and are unloaded from the coating device. The full coating process took 1.5 hours.

The particles were coated with 30% by weight (total weight of the coated particles) of mannitol.

The coated particles prepared above were tested for stability. The coated particles were kept at 30° C. and 70% relative humidity for a period of 12 weeks. The particles were examined visually for stability. The particles remained completely free of discolouration during this time.

The particles demonstrate excellent storage stability and offer relatively complication free production.

### Detergent Compositions Comprising the Particles

The particles of the present invention are particularly suitably for use in detergent compositions. In particular, the particles of the present invention are suitable for detergent compositions used in automatic cleaning machines. These include both laundry cleaning and tableware cleaning machines.

The detergent composition may take any form known in the art. Possible forms include tablets, powders, gels, pastes and liquids. The detergent compositions may also comprise a mixture of two or more forms. For example the composition may comprise a gel component and a free powder component. The particles of the present invention may be contained within the gel portion or the powder portion of the detergent composition, or contained within both portions.

Tablets may be homogeneous of composed of multi-layers. If the tablets are multi-layered then different layers may comprise different parts of the detergent composition. This may be done to increase stability or increase performance, or both. The particles of the present invention may be contained within one or more layers of the tablets.

The detergent compositions may be housed in PVOH rigid capsules or film blisters. These PVOH capsules or blisters may have a single compartment or may be multi-compartment.

Multi-compartment blisters or capsules may have different portions of the composition in each compartment, or the same composition in each compartment. The distinct regions/or compartments may contain any proportion of the total amount of ingredients as desired.

The PVOH capsules or film blisters may be filled with tablets, powders, gels, pastes or liquids, or combinations of these.

The detergent compositions may comprise any ingredients known in the art. These may include components such as builders, The builder may be either a phosphorous-containing builder or a phosphorous-free builder as desired.

If phosphorous-containing builders are also to be used it is preferred that mono-phosphates, di-phosphates, tri-polyphosphates or oligomeric-poylphosphates are used. The alkali metal salts of these compounds are preferred, in particular the sodium salts. An especially preferred builder is sodium tripolyphosphate (STPP). Conventional amounts of the phosphorous-containing builders may be used typically in the range of from 15% by weight to 60% by weight, such as from 20% by weight to 50% by weight or from 25% by weight to 40% by weight.

If a phosphorous-free builder is included it is preferably chosen from amino acid based compounds and/or succinate based compounds. The terms ‘succinate based compound’ and ‘succinic acid based compound’ are used interchangeably herein. Conventional amounts of the amino acid based compound and/or succinate based compound may be used typically in the range of from 05% by weight to 80% by weight, such as from 15% by weight to 70% by weight or from 20% by weight to 60% by weight.

Preferred examples of amino acid based compounds which may be used are MGDA (methyl-glycine-diacetic acid, and salts and derivatives thereof) and GLDA (glutamic-N,N-diacetic acid and salts and derivatives thereof). Other suitable builders are described in U.S. Pat. No. 6,426,229 which are incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

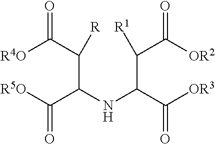

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts.

It is especially preferred according to the present invention that the builder comprises methyl-glycine-diacetic acid, glutamic-N,N-diacetic acid, tetrasodium imminosuccinate, or (hydroxy)iminodisuccinic acid and salts or derivatives thereof.

The phosphorous-free builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferably the total amount of builder present is an amount of at least 20% by weight, and most preferably at least 25% by weight, preferably in an amount of up to 70% by weight, preferably up to 65% by weight, more preferably up to 60% by weight. The actual amount used in the compositions will depend upon the nature of the builder used. If desired a combination of phosphorous-containing and phosphorous-free builders may be used.

The detergent compositions may optionally further comprise a secondary builder (or cobuilder). Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made.

Preferably the total amount of co-builder present is an amount of up to 10% by weight, preferably at least 5% by weight. The actual amount used in the compositions will depend upon the nature of the builder used.

The shaped body or detergent compositions may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity.

The shaped body and detergent compositions may comprise one or more anti-corrosion agents, especially when the detergent compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper.

The detergent compositions may include surfactants. Surfactant may also be included in the shaped body or detergent composition and any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred according to the present invention.

Non-ionic surfactants are especially preferred according to the present invention, especially for automatic dishwashing compositions. For laundry and cleaning applications (excluding automatic dishwashing) other surfactants such as anionic surfactants are preferably included and suitable types are well known in the art.

A preferred class of nonionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles, such as at least 25 moles of ethylene oxide per mole of alcohol or alkylphenol.

Particularly preferred non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30% by weight, preferably more than 50% by weight, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane. Another preferred class of nonionic surfactant can be described by the formula:

R¹O[CH₂CH(CH₃)O]ₓ[CH₂CH₂O]_{y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]ₓ[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³ H, methyl or ethyl is particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³=H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

Preferably the non-ionic surfactants are present in the shaped body or the detergent composition in an amount of from 0.1% by weight to 20% by weight, more preferably 1% by weight to 15% by weight, such as 2% to 10% by weight based on the total weight of the detergent composition.

The detergent compositions may also include enzymes. It is preferred that the enzyme is selected from proteases, lipases, amylases, cellulases and peroxidases, with proteases and amylases, especially proteases being most preferred. It is most preferred that protease and/or amylase enzymes are included in the compositions according to the invention as such enzymes are especially effective for example in dishwashing detergent compositions. Any suitable species of these enzymes may be used as desired. More than one species may be used.

The detergent compositions may also comprise bleach additives or bleach activation catalysts The composition may preferably comprise one or more bleach activators or bleach catalysts depending upon the nature of the bleaching compound. Any suitable bleach activator may be included for example TAED if this is desired for the activation of the bleach material. Any suitable bleach catalyst may be used for example manganese acetate or dinuclear manganese complexes such as those described in EP-A-1,741,774. The organic peracids such as perbenzoic acid and peroxycarboxylic acids e.g. PAP do not require the use of a bleach activator or catalyst as these bleaches are active at relatively low temperatures such as about 30° C. and this contributes to such bleach materials being especially preferred according to the present invention.

Water may be included in the detergent composition.

The detergent compositions may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity.

The detergent compositions may comprise one or more anti-corrosion agents, especially when the detergent compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, bismuth, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Zinc acetate, zinc sulphate and Ce(NO₃)₃. Any suitable source of multivalent ions may be used, with the source preferably being chosen from sulphates, carbonates, acetates, gluconates and metal-protein compounds. Zinc salts are specially preferred corrosion inhibitors.

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

Any conventional amount of the anti-corrosion agents may be included. However, it is preferred that they are present in an total amount of from 0.01% by weight to 5% by weight, preferably 0.05% by weight to 3% by weight, more preferably 0.1% by weight to 2.5% by weight, such as 0.2% by weight to 2% by weight based on the total weight.

Polymers intended to improve the cleaning performance of the detergent compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulfonated polymer is present, it is preferably present in an amount of at least 0.1% by weight, preferably at least 0.5% by weight, more preferably at least 1% by weight, and most preferably at least 3% by weight, up to 40% by weight, preferably up to 25% by weight, more preferably up to 15% by weight, and most preferably up to 10% by weight.

The detergent composition may also comprise one or more foam control agents. Suitable foam control agents for this purpose are all those conventionally used in this field, such as, for example, silicones and their derivatives and paraffin oil. The foam control agents are preferably present in amounts of 0.5% by weight or less.

The detergent compositions may also comprise minor, conventional, amounts of preservatives.

The detergent compositions may comprise between 0.5% and 50% by weight of the particles of the present invention. Preferably the detergent compositions comprise between 0.5% and 25%, more preferably between 1.0% and 10% and most preferably between 1.5% and 5% of the particles by total weight of the detergent compositions.

1. A particle comprising:
a bleach catalyst; and
a sulphonated polymer;
wherein the particle is at least partially coated by a coating material.

2. The particle according to claim 1, wherein the particle is completely coated by the coating material.

3. The particle according to claim 1, wherein the bleach catalyst comprises one or more transition element compounds.

4. The particle according to claim 1, wherein the bleach catalyst comprises a manganese compound.

5. The particle according to claim 1, wherein the bleach catalyst comprises manganese acetate, including salts and hydrates.

6. The particle according to claim 1, wherein the sulphonated polymer is an AMPS: acrylic acid copolymer.

7. The particle according to claim 1, wherein the sulphonated polymer is Acusol 588G™.

8. The particle according to claim 1, wherein the particle comprises:
between 10-90% by weight of the bleach catalyst; and
between 10-90% by weight of the sulphonated polymer.

9. The particle according to claim 1, wherein the particle comprises:
between 20-50% by weight of the bleach catalyst; and
between 50-80% by weight of the sulphonated polymer.

10. The particle according to claim 1, wherein the coating material comprises a sugar compound.

11. The particle according to claim 10, wherein the sugar compound comprises a sugar alcohol

12. The particle according to claim 11, wherein the sugar alcohol comprises mannitol.

13. The particle according to claim 12, wherein the coating consists essentially of mannitol.

14. The particle according to claim 1, wherein the coating further comprises additives.

15. The particle according to claim 1, wherein the coating material comprises between 5 and 60% by weight of the total weight of the coated particle.

16. The particle according to claim 1, wherein the coating material comprises between 20 and 40% by weight of the total weight of the coated particle.

17. The particle according to claim 1, wherein the particle comprises:
between 20-50% by weight of manganese acetate;
between 40-80% by weight of the sulphonated polymer; and
wherein the coating material is mannitol comprising between 20 and 40% by weight of the total weight of the coated particle.

18. The particle according to claim 1, wherein the particles are between 0.05 and 25 millimetres in diameter.

19. The particle according to claim 1, wherein the particles are between 0.5 and 3 millimetres in diameter.

20. A particle consists consisting essentially of a bleach catalyst, a sulphonated polymer, and a coating material.

21. The particle according to claim 1 further comprising one or more of more of a binder, disintegrant, lubricant, colourant, perfume or dye.

22. (canceled)

23. A detergent composition comprising particles of claim 1.

24. The detergent composition according to claim 23, wherein the detergent composition is an ADW composition.

25. The detergent composition according to claim 23, wherein the detergent composition comprises a powder, compressed tablet or combination thereof.
